(19) United States
(12) Patent Application Publication
(10) Pub. No.: US 2019/0137158 A1
(43) Pub. Date: May 9, 2019

(54) Thermal Recuperation Methods, Systems, and Devices

(71) Applicant: Rebound Technologies, Inc., Commerce City, CO (US)

(72) Inventors: Russell Goldfarbmuren, Denver, CO (US); Luke Erickson, Denver, CO (US)

(21) Appl. No.: 16/136,452

(22) Filed: Sep. 20, 2018

Related U.S. Application Data
(63) Continuation of application No. PCT/US2017/023356, filed on Mar. 21, 2017.
(60) Provisional application No. 62/310,888, filed on Mar. 21, 2016.

(51) Int. Cl. F25C 1/00; F25C 5/18; C09K 5/20

(52) U.S. Cl. CPC F25C 1/00; C09K 5/20; F25C 5/18

(57) ABSTRACT

Methods, systems, and devices for making a solid utilizing thermal recuperation are provided in accordance with various embodiments. Some embodiments include a method that includes combining a first material in a frozen state with a portion of a freeze point suppressant. The method may include utilizing the combined first material with the portion of the freeze point suppressant to freeze a second material. Some embodiments include combining the second material in the frozen state with another portion of the freeze point suppressant. Combining the first material in the frozen state with the portion of the freeze point suppressant may melt the first material and may form the first material in a liquid state combined with the portion of the freeze point suppressant; the combined first material in the liquid state with the freeze point suppressant has a temperature lower than a temperature of the first material in the frozen state.

### BACKGROUND

Heat transfer between different materials may be performed in a variety of ways. Heat exchangers, for example, may be utilized to transfer heat between one or more fluids. Heat exchangers may be utilized in a wide variety of technologies such as space heating, refrigeration, and air conditioning. A recuperator may provide a specific type of heat exchanger that may facilitate heat transfer inside a system to increase efficiency, for example.

While some technologies may have the ability to move heat around, such as heat exchangers, there may be a general need for new tools and techniques to recuperate heat.

### SUMMARY

Methods, systems, and devices for making a solid, such as ice, utilizing thermal recuperation are provided. For example, some embodiments include a method that may include combining a first material in a frozen state with a portion of a freeze point suppressant. The method may include utilizing the combined first material with the portion of the freeze point suppressant to freeze a second material. Some embodiments include combining the second material in the frozen state with another portion of the freeze point suppressant. In some embodiments, combining the first material in the frozen state with the portion of the freeze point suppressant melts the first material in the frozen state and forms the first material in a liquid state combined with the portion of the freeze point suppressant such that the combined first material in the liquid state with the freeze point suppressant has a temperature lower than a temperature of the first material in the frozen state.

In some embodiments, the first material and the second material are a same type of material. The same type of material may include at least water, an organic material, an ionic liquid, an inorganic material, or DMSO. In some embodiments, freeze point suppressant includes at least water, alcohol, ionic liquids, amines, ammonia, salt, non-salt soluble solids, organic liquid, inorganic liquid, triethylamine, cyclohexopuridine, mixtures of miscible materials, or a surfactant-stabilized mixtures of immiscible materials.

In some embodiments, utilizing the combined first material with the freeze point suppressant to freeze the second material includes utilizing an indirect heat exchanger thermally coupled with the combined first material with the freeze point suppressant to freeze the second material. Utilizing the indirect heat exchanger may include: exchanging heat between the combined first material and the freeze point suppressant with a first portion of a coolant passing through the indirect heat exchanger; and/or exchanging heat between the cooled first portion of the coolant with an ice maker configured to freeze the second material. Some embodiments may further include: passing a second portion of the coolant through a vapor compression cooled heat exchanger; combining the cooled second portion of the coolant with the cooled first portion of the coolant; and/or exchanging heat between the combined cooled first portion and cooled second portion of the coolant with the ice maker configured to freeze the second material.

In some embodiments, utilizing the combined first material with the freeze point suppressant to freeze the second material includes utilizing a first direct heat exchanger thermally coupled with the combined first material with the freeze point suppressant to freeze the second material. Some embodiments include: exchanging heat between a coolant and a second direct heat exchanger to freeze the second material; combining the coolant with the combined first material with the freeze point suppressant; and/or bleeding off a portion of the coolant with the combined first material with the freeze point suppressant.

In some embodiments, utilizing the indirect heat exchanger includes: passing a refrigerant through a condenser; exchanging heat between the combined first material and freeze point suppressant with the refrigerant utilizing the indirect heat exchanger after the refrigerant passes through the condenser; and/or passing the refrigerant through an expander before the refrigerant is utilized to facilitate freezing the second material. In some embodiments, the refrigerant may be utilized to facilitate freezing the second material through exchanging heat between the refrigerant and a coolant coupled with an ice maker configured to freeze the second material. In some embodiments, the refrigerant may be utilized to facilitate freezing the second material through exchanging heat between the refrigerant and a heat exchanger of an ice maker configured to freeze the second material.

In some embodiments, combining the first material in the frozen state with the portion of the freeze point suppressant includes mixing the first material in the frozen state with the portion of the freeze point suppressant through a hydraulic flow of the portion of the freeze point suppressant through the first material in the frozen state.

Some embodiments include a system that may include a tank configured to combine a first material in a frozen state with a freeze point suppressant. The system may include one or more heat exchangers thermally coupled with the combined first material and the freeze point suppressant. At least one of the one or more heat exchangers may be configured to freeze a second material.

In some embodiments, at least one of the one or more heat exchangers is configured to thermally couple a coolant with the combined first material and freeze point suppressant; the coolant may be thermally coupled with the heat exchanger configured to freeze the second material. In some embodiments, at least one of the one or more heat exchangers is configured to thermally couple a refrigerant with the combined first material and freeze point suppressant and at least one of the one or more heat exchangers is configured to thermally couple the refrigerant with the coolant. In some embodiments, the tank is configured to receive the frozen second material.

Some embodiments include a system that may include: a means for solidifying a first material; a means for combining the first material in the solidified state with a freeze point suppressant; and/or a means for thermally coupling the combined first material and the freeze point suppressant with the means for solidifying the first material.

Some embodiments include methods, systems, and/or devices as described in the specification and/or shown in the figures.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different examples may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a system in accordance with various embodiments;

FIG. 1B shows a system in accordance with various embodiments.

FIG. 1C shows a system in accordance with various embodiments.

FIG. 2 shows a system in accordance with various embodiments.

FIG. 3 shows a system in accordance with various embodiments.

FIG. 4 shows a system in accordance with various embodiments.

FIG. 5 shows a system in accordance with various embodiments.

FIG. 6 shows a system in accordance with various embodiments.

FIG. 7 shows a system in accordance with various embodiments.

FIG. 8A shows a method in accordance with various embodiments.

FIG. 8B shows a method in accordance with various embodiments.

### DETAILED DESCRIPTION

This description provides examples, and is not intended to limit the scope, applicability or configuration of the disclosure. Rather, the ensuing description will provide those skilled in the art with an enabling description for implementing embodiments of the disclosure. Various changes may be made in the function and arrangement of elements.

Thus, various embodiments may omit, substitute, or add various procedures or components as appropriate. For instance, it should be appreciated that the methods may be performed in an order different than that described, and that various stages may be added, omitted or combined. Also, aspects and elements described with respect to certain embodiments may be combined in various other embodiments. It should also be appreciated that the following systems, methods, and devices may individually or collectively be components of a larger system, wherein other procedures may take precedence over or otherwise modify their application.

Tools and techniques for producing a solid, such as ice, with thermal recuperation are provided in accordance with various embodiments. Systems in accordance with various embodiments may have a variety of components including, but not limited to, a solid making components (e.g., an ice making loop), a mixing and freeze point suppressant components with thermal recuperation, and/or refrigerant components. The interaction between different aspects of these components may provide different embodiments. These interactions can be thermal and/or physical. For example, some components may exchange heat while others exchange heat and mass.

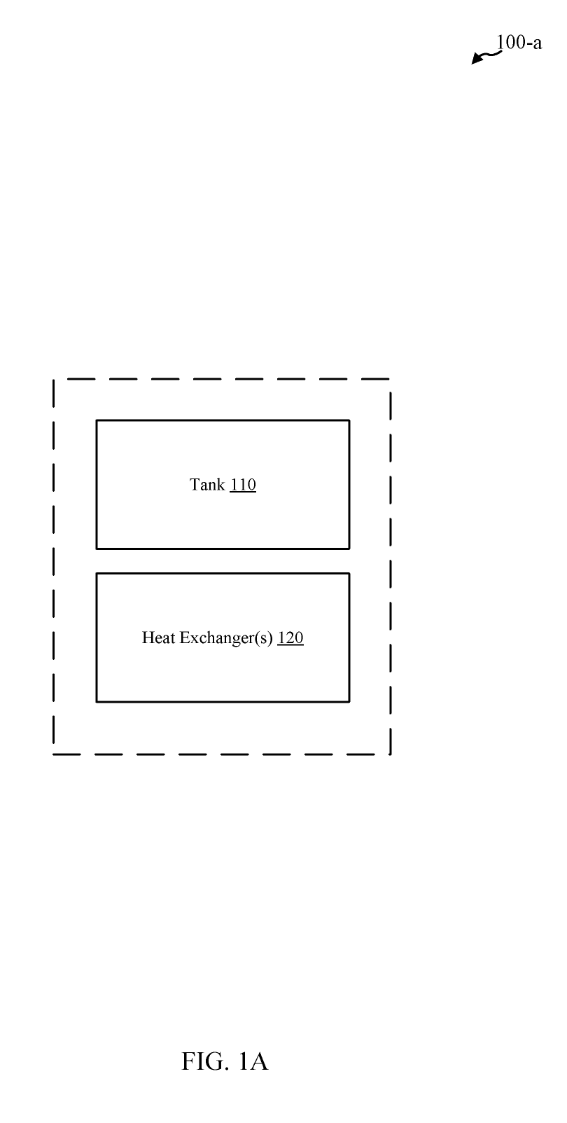

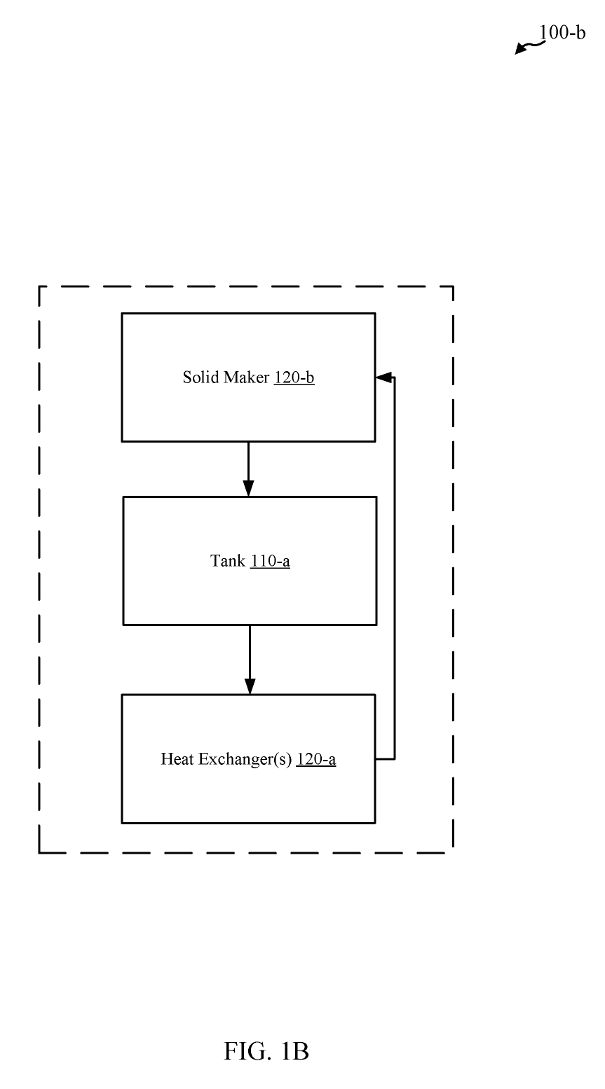

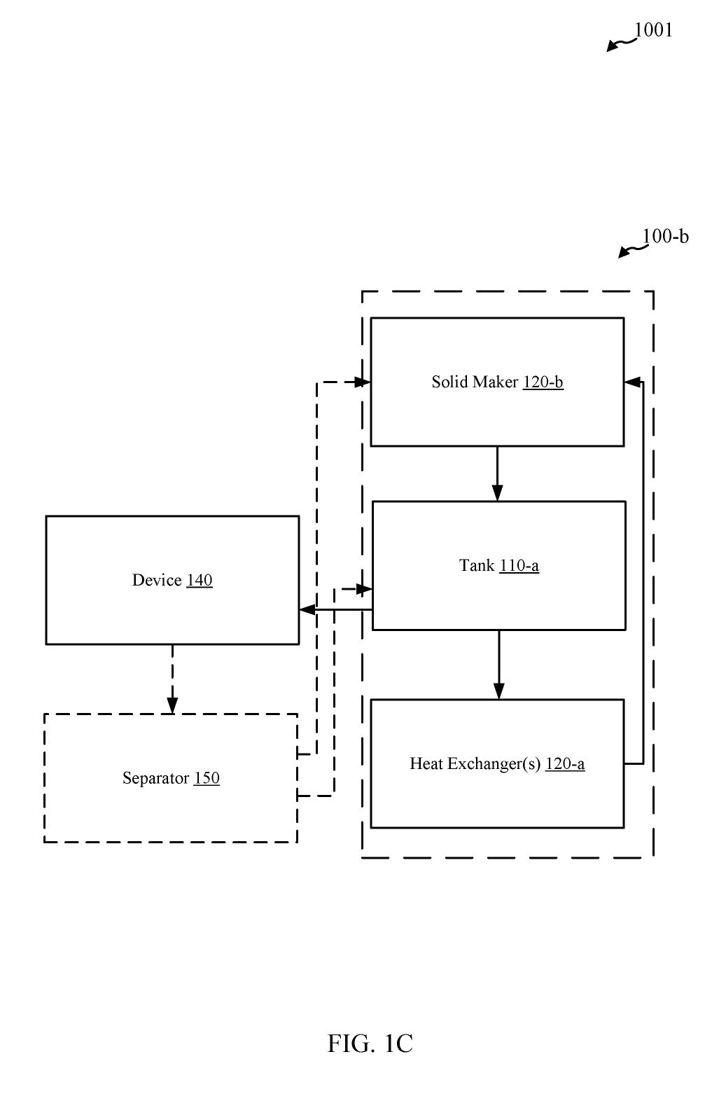

FIG. 1A shows a system 100-a in accordance with various embodiments. System 100-a may include a tank 110 and one or more heat exchangers 120. These components may be physically and/or thermally coupled with each other in a variety of different ways.

Tank 110 may be configured such that a first material in a frozen state may be combined with a portion of a freeze point suppressant. The combined first material with the portion of the freeze point suppressant may be utilized to freeze a second material utilizing the one or more heat exchangers 120. Freezing the second material may include turning the second material into a solid form of the second material, in general. Tank 110 may be utilized to combine the second material in the frozen state with another portion of the freeze point suppressant. Within tank 110, combining the first material in the frozen state with the portion of the freeze point suppressant may melt the first material in the frozen state and form the first material in a liquid state combined with the portion of the freeze point suppressant such that the combined first material in the liquid state with the freeze point suppressant has a temperature lower than a temperature of the first material in the frozen state. This may produce a sub-cooled liquid in effect.

One or more of the heat exchangers 120 that may freeze the second material may include an ice maker with thermal de-icing that may be used or an ice maker with mechanical de-icing can be used. This ice maker may be a tube, plate, flake, shell, cube, or other type. In general, these heat exchangers 120 may provide a means for form a solid from a fluid.

In some embodiments, the first material and the second material are a same type of material. The same type of material may include at least water, an organic material, an ionic liquid, an inorganic material, or DMSO. In some embodiments, the freeze point suppressant includes at least water, alcohol, triethylamine, cyclohexopuridine, ionic liquids, amines, ammonia, salt, non-salt soluble solids, organic liquid, inorganic liquid, mixtures of miscible materials, or a surfactant-stabilized mixtures of immiscible materials.

In some embodiments, utilizing the combined first material with the freeze point suppressant to freeze the second material includes utilizing an indirect heat exchanger from the one or more heat exchangers 120 thermally coupled with the combined first material with the freeze point suppressant to freeze the second material. Utilizing the indirect heat exchanger from the one or more heat exchangers 120 may include: exchanging heat between the combined first material and the freeze point suppressant with a first portion of a coolant passing through the indirect heat exchanger from the one or more heat exchangers 120; and/or exchanging heat between the cooled first portion of the coolant with an ice maker, from the one or more heat exchangers 120, configured to freeze the second material. In some embodiments, the ice maker may include other forms of heat exchangers that may form a solid in general. Some embodiments may further include one or more of the heat exchangers 120 to perform the following: passing a second portion of the coolant through a vapor compression cooled heat exchanger from the one or more heat exchangers 120; combining the cooled second portion of the coolant with the cooled first portion of the coolant; and/or exchanging heat between the combined cooled first portion and cooled second portion of the coolant with the ice maker from the one or more heat changers 120 configured to freeze the second material.

In some embodiments, utilizing the combined first material with the freeze point suppressant to freeze the second material includes utilizing a first direct heat exchanger from the one or more heat exchangers 120 thermally coupled with the combined first material with the freeze point suppressant to freeze the second material. Some embodiments include: exchanging heat between a coolant and a second direct heat exchanger from the one or more heat exchangers 120 to freeze the second material; combining the coolant with the combined first material with the freeze point suppressant; and/or bleeding off a portion of the coolant with the combined first material with the freeze point suppressant.

In some embodiments, utilizing the indirect heat exchanger from the one or more heat exchangers 120 includes: passing a refrigerant through a condenser; exchanging heat between the combined first material and freeze point suppressant with the refrigerant utilizing the indirect heat exchanger after the refrigerant passes through the condenser; and/or passing the refrigerant through an expander before the refrigerant is utilized to facilitate freezing the second material. In some embodiments, the refrigerant may be utilized to facilitate freezing the second material through exchanging heat between the refrigerant and a coolant coupled with an ice maker configured to freeze the second material. In some embodiments, the refrigerant may be utilized to facilitate freezing the second material through exchanging heat between the refrigerant and a heat exchanger of an ice maker configured to freeze the second material.

In some embodiments, the tank 110 may be configured for combining the first material in the frozen state with the portion of the freeze point suppressant such that the combining may involve mixing the first material in the frozen state with the portion of the freeze point suppressant through a hydraulic flow of the portion of the freeze point suppressant through the first material in the frozen state.

As noted above, system 100-a may include tank 110 configured to combine the first material in the frozen state with the freeze point suppressant. The system 100-a may include the one or more heat exchangers 120, which may be thermally coupled with the combined first material and the freeze point suppressant. At least one of the one or more heat exchangers 120 may be configured to freeze or otherwise make solid the second material.

In some embodiments, at least one of the one or more heat exchangers 120 is configured to thermally couple a coolant with the combined first material and freeze point suppressant; the coolant may be thermally coupled with the heat exchanger configured to freeze the second material. In some embodiments, at least one of the one or more heat exchangers 120 is configured to thermally couple a refrigerant with the combined first material and freeze point suppressant and at least one of the one or more heat exchangers 120 is configured to thermally couple the refrigerant with the coolant. In some embodiments, the tank 110 is configured to receive the frozen second material.

System 100-a may provide a means for solidifying a first material, such as through the use of one or more of the one or more heat exchangers 120; a means for combining the first material in the solidified state with a freeze point suppressant, such as through the use of the tank 110; and/or a means for thermally coupling the combined first material and the freeze point suppressant with the means for solidifying the first material, such as through the use of one or more of the one or more heat exchangers 120.

FIG. 1B shows a system 100-b in accordance with various embodiments. System 100-b may include a tank 110-a, one or more heat exchangers 120-a, and/or a solid maker 120-b, which may be an example of a heat exchanger. These components may be physically and/or thermally coupled with each other in a variety of different ways. System 100-b may be an example of system 100-a of FIG. 1A.

Solid maker 120-b may in general solidify a first material, which may include freezing the first material to produce a first material in a frozen state. The solidified material may go into tank 110-a, where the first material in a frozen state, or more generally a solid state, may be combined with a portion of a freeze point suppressant. The combined first material with the portion of the freeze point suppressant may be utilized to freeze a second material utilize the one or more heat exchangers 120-a and/or solid maker 120-b. For example, the one or more heat exchangers 120-a may be thermally coupled either directly or indirectly with the solid maker 120-b.

FIG. 1C shows a system 1001 in accordance with various embodiments. System 1001 may include subsystem 100-b, such as from FIG. 1B. Subsystem 100-b may include tank 110-a, one or more heat exchangers 120-a, and/or solid maker 120-b, which may be an example of a heat exchanger. These components may be physically and/or thermally coupled with each other in a variety of different ways. System 1001 may also include a device 140. A portion of the combined first material with the freeze point suppressant may be utilized to boost thermally the device 140, such as an electrical generator, a heat engine, a refrigerator, and/or freezer. Boosting device 140 may include absorbing heat from the device 140. Through absorbing heat from device 140, the efficiency of an electrical generation system, other thermodynamic systems, and/or devices may be boosted. This may include improving the efficiency of some devices. Some embodiments may be economically beneficial.

In some embodiments, the portion of the combined first material with the freeze point suppressant may go from the device 140 to a separator 150, where the first material and the freeze point suppressant may be separated. In some cases, the separated freeze point suppressant may be reintroduced into tank 110-a. The separated first material may be directed to the solid maker 120-b, where it may be solidified and utilized in tank 110-a. Separator 150 may separate the combined first material and the freeze point suppressant utilizing a membrane process to separate the first material and freeze point suppressant. Other separation techniques may be utilized by separator 150 including, but not limited to, separating the first material and freeze point suppressant utilizing at least a photosensitive process to separate the first material and freeze point suppressant, a distillation process to separate the first material and the freeze point suppressant, a liquid-liquid extraction process to separate the first material and freeze point suppressant, and/or a chemically induced solubility change extraction process. In some embodiments, separator 150 may utilize techniques including, but not limited to, reverse osmosis, nano-filtration, photonic driven precipitation, precipitation by chemical reaction, precipitation by solubility change, surfactant absorption, ion exchange, activated carbon absorption, flash separation, distillation, multi-effect distillation, vapor compression distillation, evaporation, membrane distillation, gas permeable membrane separation, liquid-liquid extraction, gas stripping, fractional distillation, and/or freeze distillation, among others. In some specific embodiments, the separator 150 may utilize adiabatic distillation, diabatic distillation, and/or lower critical solution temperature separation. In some cases, separator 150 may include multiple devices and/or components that may couple with the other aspects of system 1001.

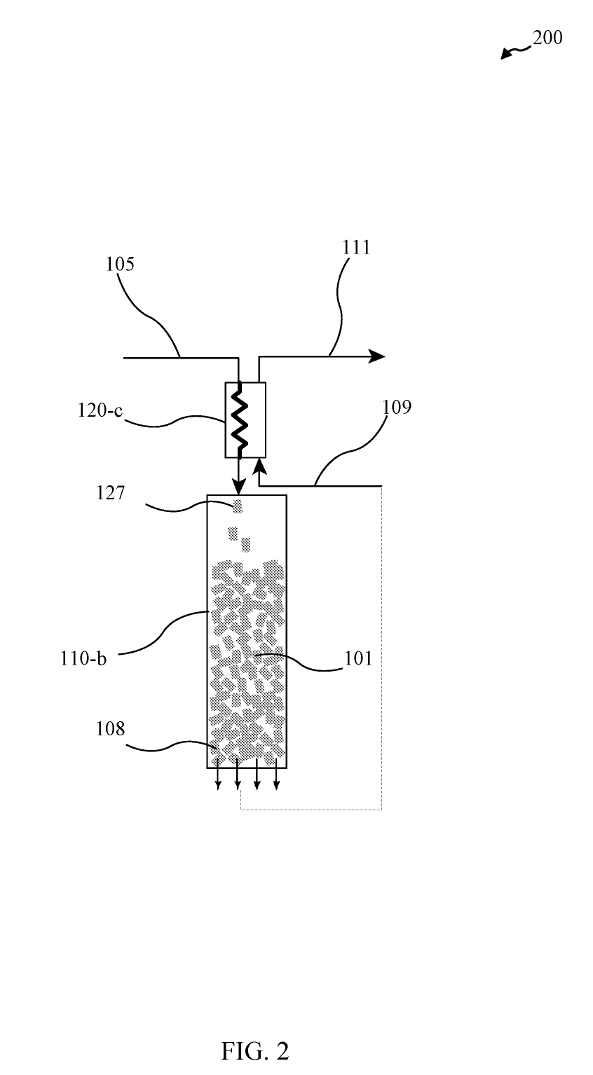

Turning now to FIG. 2, a system 200 in accordance with various embodiments is provided. System 200 may be an example of system 100-a of FIG. 1A and/or system 100-b of FIG. 1B. In system 200, a fluid 105 may provide the liquid form of the solid 101 in the tank 110-b. Heat may be removed from the solid packed bed as it may be formed by the removal of latent heat. Thus, the inlet 127 to the packed bed 101 may be a solid. Solid 101 may be formed by the removal of heat from the inlet stream. The fluid 105 may be an example of the first material and/or second material as discussed with respect to system 100-a of FIG. 1A.

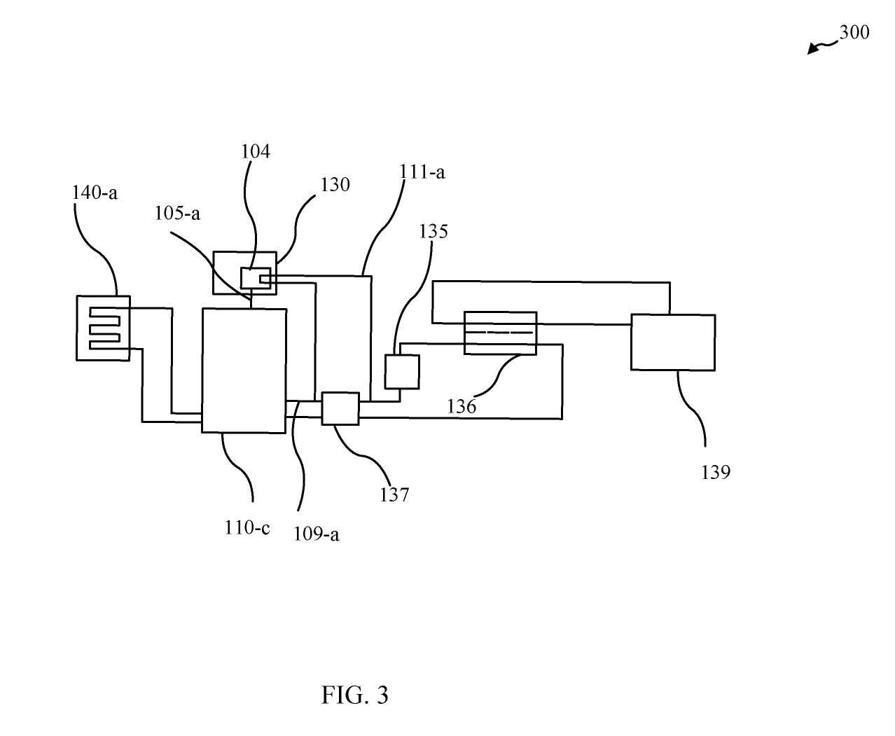

The fluid 105 as a liquid may enter a heat exchanger 120-c, which may be capable of producing solid product. This heat exchanger 120-c may be cooled by a second fluid 109, which may be warmed to a warmer temperature 111. In some cases, the second fluid 109 may come from the outlet 108 of tank 110-b. This liquid 109 may be formed from combining of the packed bed 101 with a freeze point suppressant. The fluid 105 may be converted into the solid entering the packed bed at the inlet 127. This may create more solid than may otherwise be available to the system (such as in system 300 of FIG. 3), which may rely on the melting of the solid. Thus, the heat may still be recuperated into the packed bed by the heat exchanger 120-c, even though the temperature of the solid at the inlet 127 and outlet 108 may remain the same. The available mass flow of solid at the inlet 127 may be increased by the additional formation of solid and this may create the same systematic increase in efficiency as cooling the solid between the inlet and outlet.

Turning now to FIG. 3, a system 300 is provided in accordance with various embodiments. System 300 may be an example of system 100-a of FIG. 1A, system 100-b of FIG. 1B, system 1001 of FIG. 1C, and/or system 200 of FIG. 2. System 300 may utilize a variant of fluid materials (sometimes referred to as first or second materials in a liquid state), freeze point suppressants, devices, and/or freeze point suppressant-first and/or second material separation methods. Merely by way of example, system 300 may utilize water as the first material and/or second material in a liquid state and an ionic material as a freeze point suppressant. System 300 may also be configured to boost a device, such as a freezer. System 300 may include a separator, such as a hydrophobic gas permeable membrane. Other types of devices may be boosted and other separation techniques may be utilized.

This example may use water as the first material and/or second material and an ionic material as the freeze point suppressant, for example. Boosting the output of a freezer may help avoid the purchase of electricity, for example. While system 300 may be described utilizing specific first materials and/or second materials, freeze point suppressants, devices, and/or separation techniques, this may be for clarity purposes and other first materials and/or second materials, freeze point suppressants, devices, and/or separation techniques may be utilized.

System 300 may utilize a variety of first materials in a liquid state. For example, water may be frozen by an ice harvester 130; ice harvester 130 may be an example of one of the one or more heat exchangers 120 of system 100-a and/or the solid maker 120-b of system 100-b. The ice harvester 130 may include one or more heat exchangers 104.

The frozen water may be stored for a prescribed amount of time in the ice tank 110-c, with minimal melting in some cases. In some examples, the water may be pure. In some cases, the frozen water may be fully or partially solid.

In some cases, in the ice tank 110-c, the ice or other solid in tank 110-c may be mixed with a material suppressing its freeze point. The ice, for example, may be entropically melted until it may reach an equilibrium point with the freeze point suppressant. In some cases, the ice and freeze point suppressant may be mixed after the ice moves into and/or through the bottom portion of tank 110-c. This may result in a combined first material with freeze point suppressant.

In some embodiments, a portion 109-a of the combined first material with the freeze point suppressant may pass to the ice harvester 130, where its lower temperature may be utilized to generate additional ice. The additional ice may then be introduced into tank 110-c.

For example, cold fluid 109-a may be separated from the flow before the regenerative heat exchanger 137 and may instead run through heat exchanger 104, cooling fluid 105-a, and may exit as a warmer fluid 111-a at a higher temperature, where it may then flow to the heater 135; this fluid may be referred to as a second fluid in some cases. Fluid 105-a may be an example of the first fluid and/or second fluid as discussed with respect to system 100-a of FIG. 1A. In some cases, fluid 105-a, after being cooled, may be recirculated through tank 110-c and the solid contained within the tank. Cold fluid 109-a may come from the first material-freeze point suppressant mixture.

A portion of the combined first material and the freeze point suppressant mixture may be used to cool the environment inside a freezer 140-a so that no electricity, or less electricity, may be used, for example. In general, this mixture may be utilized to boost a variety of devices beside a freezer 140-a, such as an electrical generator, a heat engine, and/or refrigerator.

After cooling or boosting the freezer 140-a, a portion of the mixture may be run through a regenerative heat exchanger 137, which may heat it to ambient temperature. The mixture may then be run into a heater 135, where it may be heated to a separation temperature. It then may be run through a gas permeable hydrophobic membrane 136, where water vapor may be extracted and the brine may be concentrated. The water vapor may be condensed and stored in the water tank 139. Regenerator 137, heater 135, and/or membrane 136 may be examples of one or more aspects of a separator, such as separator 150 of FIG. 1C. Other separation techniques may be utilized as noted above.

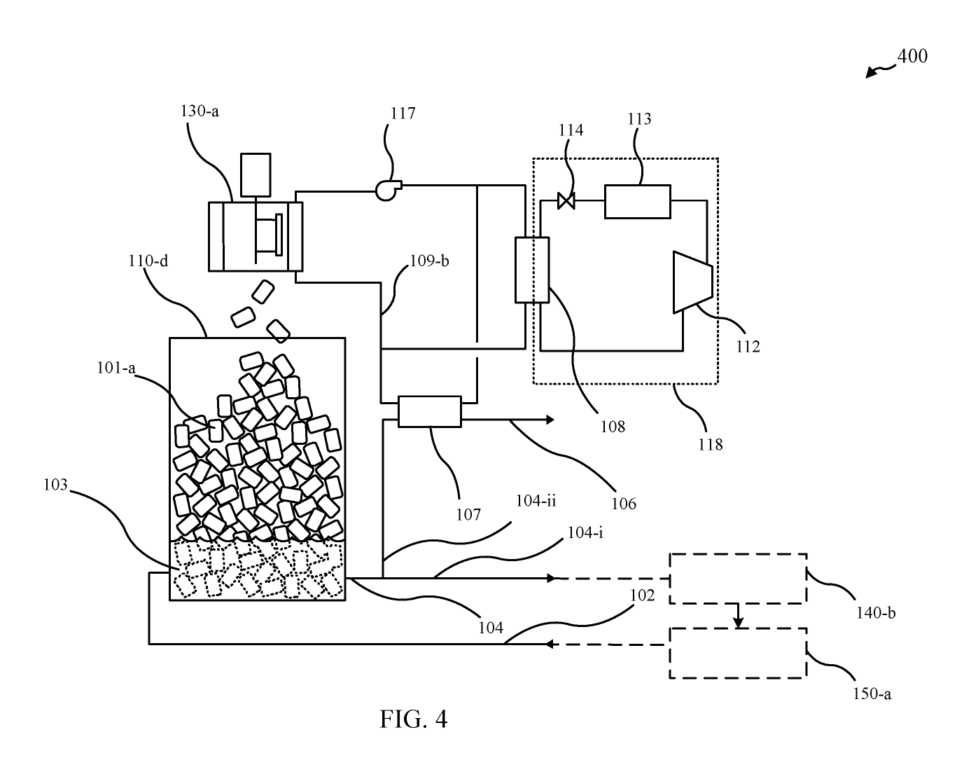

FIG. 4 provides a system 400 in accordance with various embodiments. System 400 may be an example of aspects of system 100-a of FIG. 1A, system 100-b of FIG. 1B, system 100-c of FIG. 1C, system 200 of FIG. 2, and/or system 300 of FIG. 3. System 400 may provide for indirect thermal recuperation tied to an ice maker loop, or a means for making a solid in general.

In this embodiment, ice 101-a may collect in a tank 110-d. At the bottom of tank 110-d may be a liquid 103, which may include water (which may be referred to as a first material in a liquid state in some cases) and a concentrated freeze point suppressant 102, which may be introduced into the tank 110-d. The area of the tank 110-d that may be filled with liquid may be known as the mixing region, where ice and this solution may be mixed via the hydraulic flow of the material through the ice, for example. This may produce an outlet stream of subcooled liquid 104, a portion 104-i of which may be utilized for providing refrigeration in some cases, for example. The liquid 104 may in general be cooler than the freeze point of water. Liquid 104-i may be in general utilized to boost a device 140. A portion of this liquid 104-ii can be used to provide thermal recuperation to the production of ice. This may be accomplished using a heat exchanger 107, which may cool an intermediate ice maker coolant 109-b. Heat exchanger 107 may be an example of the one or more heat exchangers 120 or 120-a of system 100-a or system 100-b, respectively. This may produce a warmed water-freeze point suppressant stream 106.

System 400 may include an ice maker loop, which may include a coolant 109-b that may be circulated by a circulation pump 117; these may be examples of aspects of the one or more heat exchangers 120 of system 100-a or solid maker 120-b of system 100-b. The coolant 109-b may flow through two heat exchangers in parallel. One path may pass through a vapor compression cooled heat exchanger 108, while the other may pass through the thermal recuperation heat exchanger 107. The two cooled streams may be mixed and flow into ice maker 130-a, where they may produce ice from pure water. Ice maker 130-a may be an example of the one or more heat exchangers 120 of system 100-a or the solid maker 120-b of system 100-b, for example. While ice maker 130-a may reflect a flake ice maker, other types of ice maker, or solid maker more generally, may be utilized, including but not limited to, tube, plate, shell, and/or cube ice makers.

System 400 may include a refrigeration loop 118 that may include a refrigerant being circulated by a compressor 112. After being compressed, the refrigerant may flow to a condenser 113, where it may condense and flow to an expansion valve 114 and then to a heat exchanger 108 where it may evaporate and cool the intermediate ice maker loop.

In some embodiments, system 400 may include a separator 150-a, which may be utilized to separate the combined first material and freeze point suppressant 104-i. This may be received after the mixture has been utilized to boost device 140-b in some embodiments, though some embodiments may not include a boosted device 140-b. In some embodiments, the freeze point suppressant 102 produced may be direct back to the tank 110-d. The first material as a liquid, such as liquid water, may be directed to the ice maker 130-a in some embodiments, where it may be utilized to generate additional ice for the ice tank 110-d.

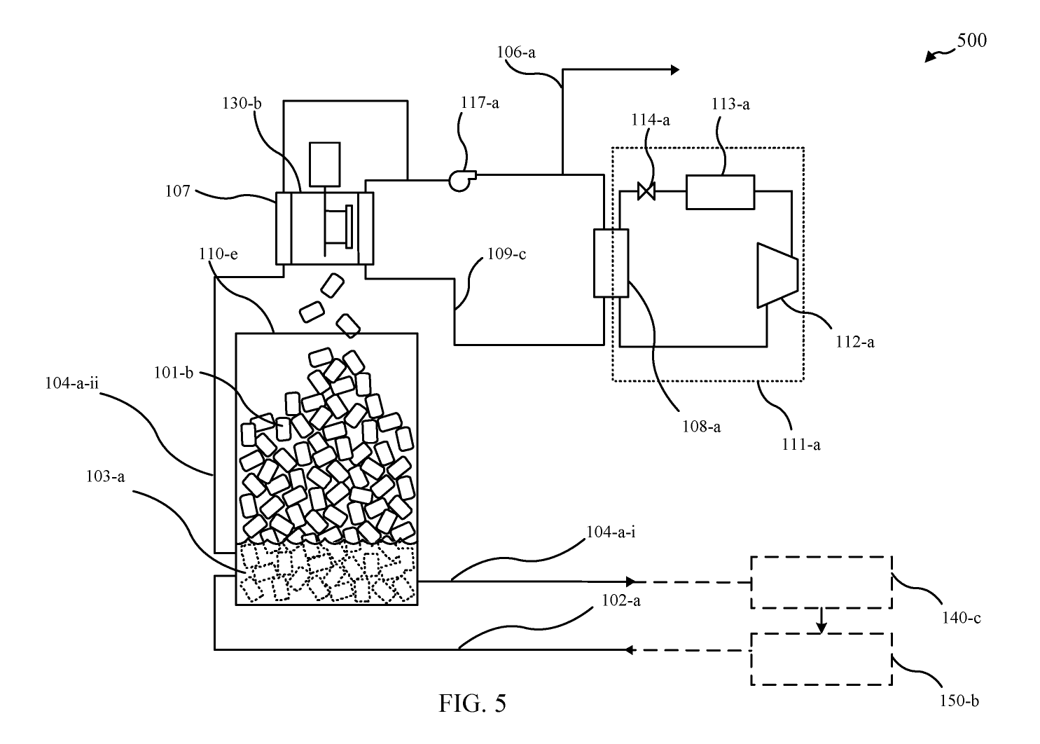

FIG. 5 provides a system 500 in accordance with various embodiments. System 500 may be an example of aspects of system 100-a of FIG. 1A, system 100-b of FIG. 1B, system 1001 of FIG. 1C, system 200 of FIG. 2, and/or system 300 of FIG. 3. System 500 may involve direct thermal recuperation tied to an ice maker loop, or a means for making a solid in general. In this embodiment, ice 101-b may collect in tank 110-e. At the bottom of this tank 110-e may be a liquid 103-a, which may include water and a concentrated freeze point suppressant 102-a. The water may be, in general, a first material and/or second material in a liquid state. The area of the tank 110-e filled with liquid may be known as the mixing region, where ice and this solution may be mixed via the hydraulic flow of the material through the ice. This may produce one or more outlet stream(s) of subcooled liquid 104-a-i/104-a-ii, which may be capable of providing refrigeration, for example. For example, a portion of the liquid 104-a-i may be utilized to boost thermally a device 140-c, which may include a refrigerator, for example. A portion of this liquid 104-a-ii may be used to provide thermal recuperation for the production of ice, for example. This may be accomplished by directly flowing this stream to the ice maker 130-b, or a solid maker in general, where a second heat exchanger 107 may produce ice directly. Heat exchanger 107 may be an example of the one or more heat exchangers 120 of system 100-a or heat exchangers 120-a of system 100-b, for example. The outlet of this process may join the ice maker loop and may be later bled off 106-a to keep the mass of fluid in the system constant.

System 500 may include an ice maker loop that may include a coolant 109-c that may be circulated by a circulation pump 117-a. Excess liquid may be bled out of the system at the higher temperature 106-a to keep the volume of liquid in the loop constant.

The remaining liquid may flow through the refrigerant expander 108-a where it may be cooled. The fluid then may flow through the ice maker 130-b were its chill may be used to produce ice. These may be examples of aspects of the one or more heat exchangers 120 of system 100-a or solid maker 120-b of system 100-b, for example.

System 500 may include a refrigerant loop 111-a that may be setup like a conventional vapor compression system utilizing a compressor 112-a, which may produce compressed gas that may be condensed in the condenser 113-a, may be expanded in the expander 114-a, and may evaporate in the evaporator 108-a.

In some embodiments, system 500 may include a separator 150-b, which may be utilized to separate combined first material and freeze point suppressant. This may be received after the mixture has been utilized to boost device 140-c in some embodiments, though some embodiments may not include a device 140-c. In some embodiments, the freeze point suppressant 102-a produced may be direct back to the tank 110-e. The first material as a liquid, such as liquid water, may be directed to the ice maker 130-b in some embodiments, where it may be utilized to generate additional ice for the ice tank 110-e.

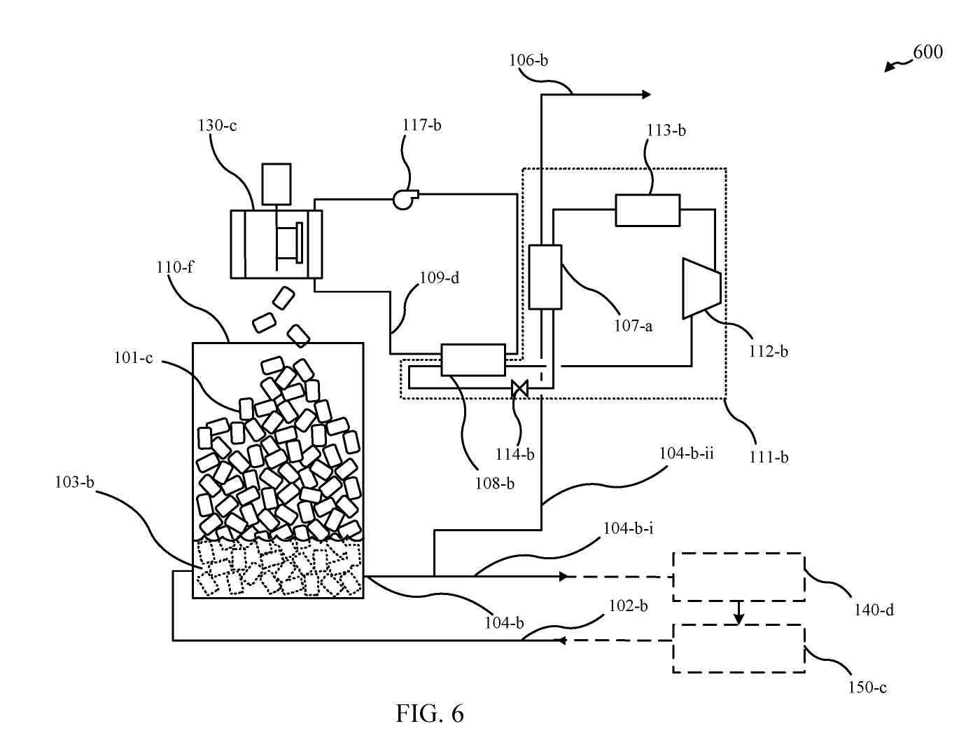

FIG. 6 shows a system 600 in accordance with various embodiments. System 600 may be an example of aspects of system 100-a of FIG. 1A, system 100-b of FIG. 1B, system 1001 of FIG. 1C, system 200 of FIG. 2, and/or system 300 of FIG. 3. System 600 may provide for indirect thermal recuperation that may be tied to a refrigerant loop 111-b. In this embodiment, ice 101-c may collect in tank 110-f. At the bottom of this tank 110-f, a liquid 103-b, which may be water and a concentrated freeze point suppressant 102-b may be formed. The water may be in general a first material in a liquid state. The area of the tank filled with liquid may be known as the mixing region, where ice 101-c and this solution may be mixed via the hydraulic flow of the material through the ice. This may produce an outlet stream of liquid 104-b, which may be colder than the freeze point of water. A portion of the liquid 104-b-i may provide for refrigeration or other purposes. For example, a portion of the liquid 104-b-i may be utilized to boost thermally a device 140-d, which may include a refrigerator.

A portion of this liquid 140-b-ii may be used to provide thermal recuperation for the production of ice. This may be accomplished by flowing this stream to the refrigerant loop 111-b, where it may flow through a heat exchanger 107-a where it sub-cools the liquid refrigerant exiting the condenser 113-b before it may enter the expander 114-b, which may effectively boost the performance of the refrigerant loop 111-b. One of more of the components of refrigerant loop 111-b may be aspects or examples the one or more heat exchangers 120 of system 100-a or heat exchangers 120-a of system 100-b, for example.

System 600 may include an ice maker loop that may be configured as an indirect loop using a coolant 109-d, which may be circulated by a circulation pump 117-b. It may enter a heat exchanger 108-b where it may be cooled before it may enter the ice maker 130-c, where it may produce ice.

Refrigerant loop 111-b may be boosted by the existence of a liquid subcooler 107-a, which may cool the liquid refrigerant at the outlet of the condenser 113-b before the expander 114-b. After expansion in this loop, the evaporator 108-b may be able to provide more cooling than would normally be possible at the same compressor 112-b work. Excess liquid may be bled out of the system at the higher temperature 106-b to keep the volume of liquid in the loop constant.

In some embodiments, system 600 may include a separator 150-c, which may be utilized to separate combined first material and freeze point suppressant. This may be received after the mixture has been utilized to boost device 140-d, though some embodiments may not include a device 140-d. In some embodiments, the freeze point suppressant 102-b produced may be direct back to the tank 110-f. The first material as a liquid, such as liquid water, may be directed to the ice maker 130-c in some embodiments, where it may be utilized to generate additional ice for the ice tank 110-f.

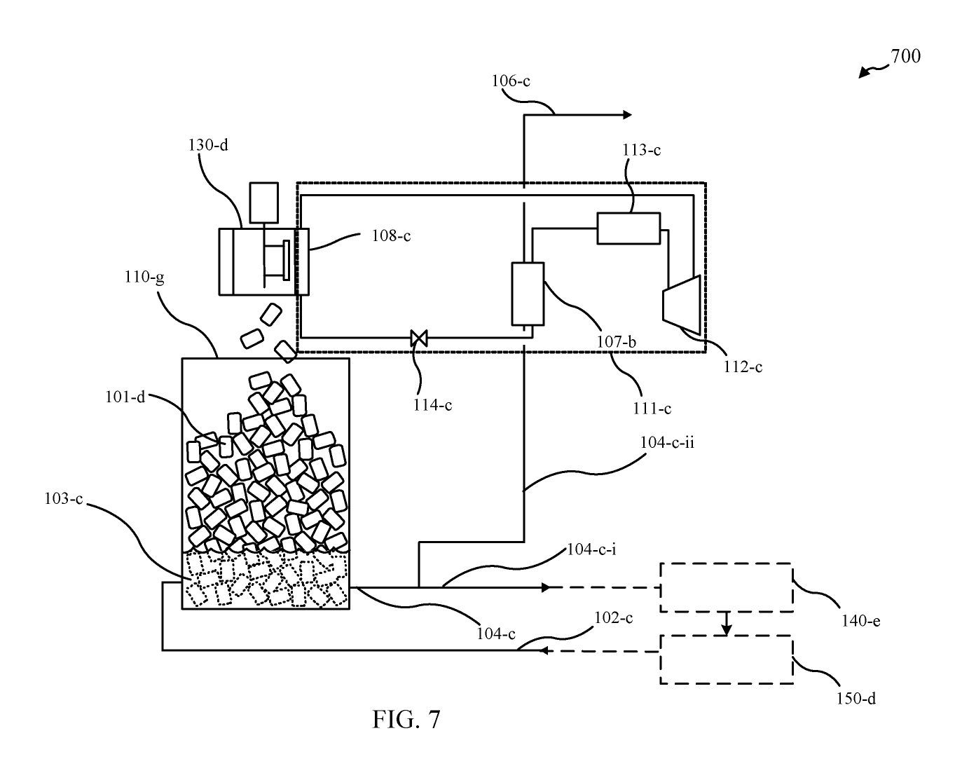

FIG. 7 provides a system 700 in accordance with various embodiments. System 700 may be an example of aspects of system 100-a of FIG. 1A, system 100-b of FIG. 1B, system 1001 of FIG. 1C, system 200 of FIG. 2, and/or system 300 of FIG. 3. System 700 may provide for indirect thermal recuperation tied to refrigerant loop 111-c, which may also be an ice maker loop. In this embodiment, ice 101-d may collect in a tank 110-g. At the bottom of this tank 110-g, liquid 103-c, which may include water and a concentrated freeze point suppressant 102-c may be formed. The water may be in general a first material in a liquid state The area of the tank filled with liquid may be known as the mixing region where ice and this solution may be mixed via the hydraulic flow of the material through the ice. This may produce an outlet stream of subcooled liquid 104-c, a portion 104-c-i which may be capable of providing refrigeration or boosting a device 140-e in general. For example, the portion of the liquid 104-ci may be utilized to boost thermally a device 140-e, which may include a refrigerator. A portion of this liquid 104-c-ii may be used to provide thermal recuperation for the production of ice. This may be accomplished by flowing this stream to the refrigerant loop 111-c, where it may flow through a heat exchanger 107-b, where it may subcool the liquid refrigerant exiting the condenser 113-c before it may enter the expander 114-c, which may effectively boost the performance of the refrigerant loop 111-c.

In this embodiment, the ice maker loop 108-c and refrigerant loop 111-c are the same loop and there may be no intermediary coolant used. One of more of the components of refrigerant loop 111-c and/or ice maker loop 108-c may be aspects or examples the one or more heat exchangers 120 of system 100-a or heat exchangers 120-a of system 100-b, for example.

Refrigerant loop 111-c may be boosted by the existence of a liquid subcooler 107-b, which may cool the liquid refrigerant at the outlet of the condenser 113-c before the expander 114-c. After expansion in this loop, the evaporator 108-c may be able to provide more cooling than may normally be possible at the same compressor 112-c work. The evaporator of this loop may be directly integrated into the ice maker and thus the refrigerant evaporation cooling may be directly converted into ice production.

In some embodiments, system 700 may include a separator 150-d, which may be utilized to separate combined first material and freeze point suppressant. This may be received after the mixture has been utilized to boost device 140-e, though some embodiments may not include a device 140-e. In some embodiments, the freeze point suppressant 102-c produced may be direct back to the tank 110-g. The first material as a liquid, such as liquid water, may be directed to the ice maker 130-d in some embodiments, where it may be utilized to generate additional ice for the ice tank 110-g.

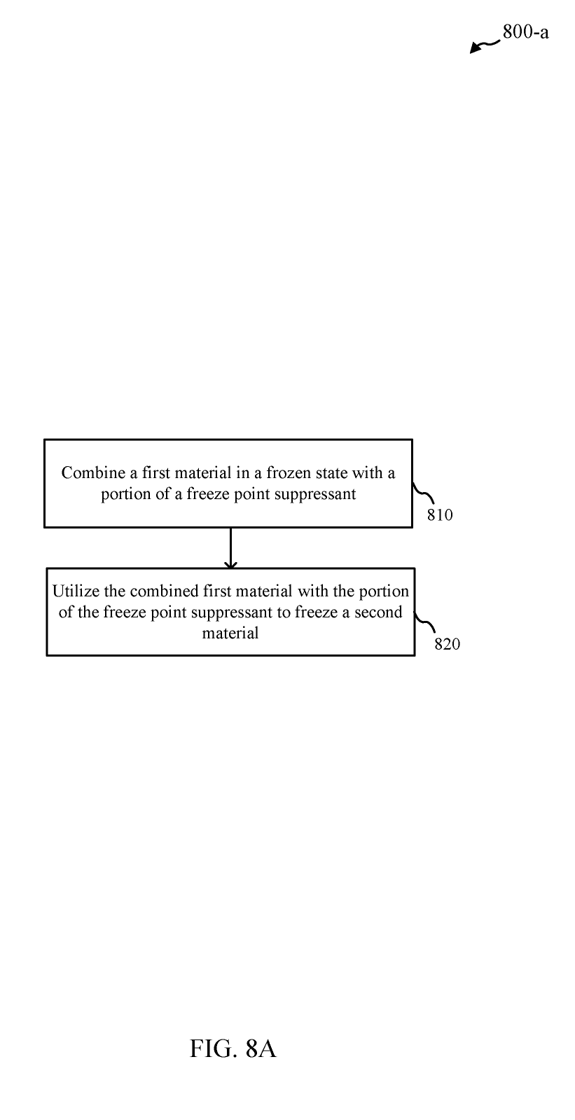

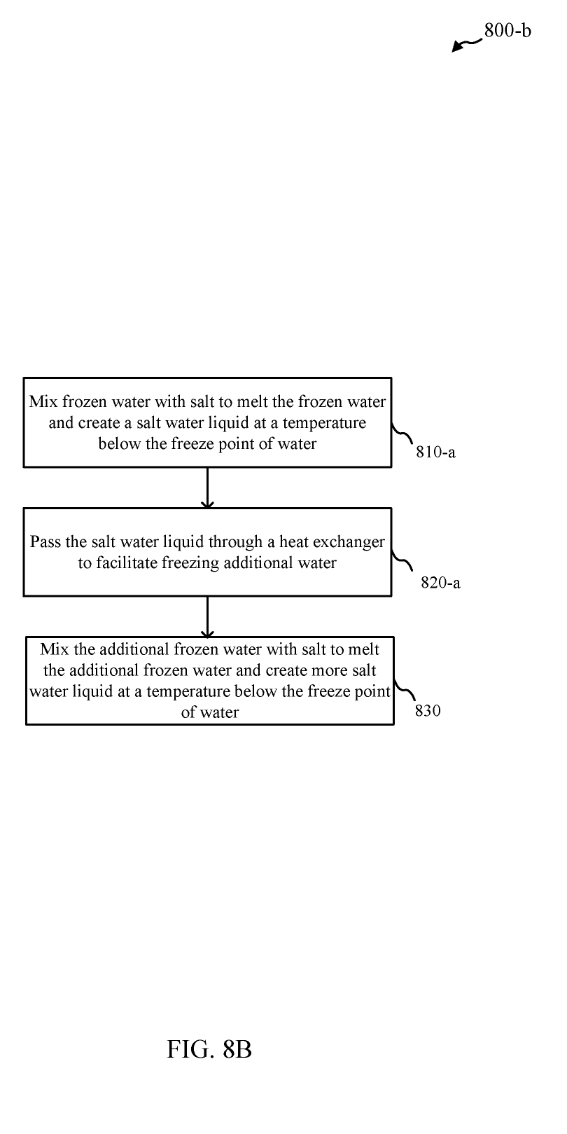

FIG. 8A shows a flow diagram of a method 800-a of thermal recuperation in accordance with various embodiments. Method 800-a may be implemented utilizing systems such as those shown in system 100-a of FIG. 1A, system 100-b of FIG. 1B, system 1001 of FIG. 1C, system 200 of FIG. 2, system 300 of FIG. 3, system 400 of FIG. 4, system 500 of FIG. 5, system 600 of FIG. 6, and/or system 700 of FIG. 7. In FIG. 8A, the specific selection of steps shown and the order in which they are shown is intended merely to be illustrative. It is possible for certain steps to be performed in alternative orders, for certain steps to be omitted, and for certain additional steps to be added according to different embodiments of the invention. Some but not all of these variants are noted in the description that follows.

At block 810, a first material in a frozen state or otherwise solid state may be combined with a portion of a freeze point suppressant. At block 820, the combined first material with the portion of the freeze point suppressant may be utilized to freeze a second material.

Some embodiments of method 800 include combining the second material in the frozen state with another portion of the freeze point suppressant. In some embodiments, combining the first material in the frozen state with the portion of the freeze point suppressant melts the first material in the frozen state and forms the first material in a liquid state combined with the portion of the freeze point suppressant such that the combined first material in the liquid state with the freeze point suppressant has a temperature lower than a temperature of the first material in the frozen state.

In some embodiments of method 800-a, the first material and the second material are a same type of material. The same type of material may include at least water, an organic material, an ionic liquid, an inorganic material, or DMSO. In some embodiments, freeze point suppressant includes at least water, alcohol, ionic liquids, amines, ammonia, salt, non-salt soluble solids, organic liquid, inorganic liquid, mixtures of miscible materials, or a surfactant-stabilized mixtures of immiscible materials.

In some embodiments of method 800-a, utilizing the combined first material with the freeze point suppressant to freeze the second material includes utilizing an indirect heat exchanger thermally coupled with the combined first material with the freeze point suppressant to freeze the second material. Utilizing the indirect heat exchanger may include: exchanging heat between the combined first material and the freeze point suppressant with a first portion of a coolant passing through the indirect heat exchanger; and/or exchanging heat between the cooled first portion of the coolant with an ice maker configured to freeze the second material. Some embodiments may further include: passing a second portion of the coolant through a vapor compression cooled heat exchanger; combining the cooled second portion of the coolant with the cooled first portion of the coolant; and/or exchanging heat between the combined cooled first portion and cooled second portion of the coolant with the ice maker configured to freeze the second material.

In some embodiments of method 800-a, utilizing the combined first material with the freeze point suppressant to freeze the second material includes utilizing a first direct heat exchanger thermally coupled with the combined first material with the freeze point suppressant to freeze the second material. Some embodiments include: exchanging heat between a coolant and a second direct heat exchanger to freeze the second material; combining the coolant with the combined first material with the freeze point suppressant; and/or bleeding off a portion of the coolant with the combined first material with the freeze point suppressant.

In some embodiments of method 800-a, utilizing the indirect heat exchanger includes: passing a refrigerant through a condenser; exchanging heat between the combined first material and freeze point suppressant with the refrigerant utilizing the indirect heat exchanger after the refrigerant passes through the condenser; and/or passing the refrigerant through an expander before the refrigerant is utilized to facilitate freezing the second material. In some embodiments, the refrigerant may be utilized to facilitate freezing the second material through exchanging heat between the refrigerant and a coolant coupled with an ice maker configured to freeze the second material. In some embodiments, the refrigerant may be utilized to facilitate freezing the second material through exchanging heat between the refrigerant and a heat exchanger of an ice maker configured to freeze the second material.

In some embodiments of method 800-a, combining the first material in the frozen state with the portion of the freeze point suppressant includes mixing the first material in the frozen state with the portion of the freeze point suppressant through a hydraulic flow of the portion of the freeze point suppressant through the first material in the frozen state.

FIG. 8B shows a flow diagram of a method 800-b of thermal recuperation in accordance with various embodiments. Method 800-b may be implemented utilizing systems such as those shown in system 100-a of FIG. 1A, system 100-b of FIG. 1B, system 1001 of FIG. 1C, system 200 of FIG. 2, system 300 of FIG. 3, system 400 of FIG. 4, system 500 of FIG. 5, system 600 of FIG. 6, and/or system 700 of FIG. 7. Method 800-a may be an example of system 800-a of FIG. 8B. In FIG. 8B, the specific selection of steps shown and the order in which they are shown is intended merely to be illustrative. It is possible for certain steps to be performed in alternative orders, for certain steps to be omitted, and for certain additional steps to be added according to different embodiments of the invention. Some but not all of these variants are noted in the description that follows.

At block 810-a, frozen water may be mixed with salt to melt the frozen water and create a salt water liquid at a temperature below the freeze point of water. At block 820-a, the salt water liquid may pass through a heat exchanger to facilitate freezing additional water. This may utilize a variety of direct and/or indirect heat exchange techniques to facilitate the freezing of the additional water. At block 830, the additional frozen water may be mixed with salt to melt the additional frozen water and create more salt water liquid at a temperature below the freeze point of water.

These embodiments may not capture the full extent of combination and permutations of materials and process equipment. However, they may demonstrate the range of applicability of the method, devices, and/or systems. The different embodiments may utilize more or less stages than those described. The different embodiments may also utilize aspects of each other. In each of these embodiments, the heat engines may be replaced by fuel cells or other systems enhanced by the presence of very cold materials, for example. The boosting techniques in general may be utilized with different thermodynamic systems and/or devices. Furthermore, each embodiment can work with a large array of heat engines running of a large array of energy sources.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of stages may be undertaken before, during, or after the above elements are considered. Accordingly, the above description should not be taken as limiting the scope of the invention.

What is claimed is:

1. A method comprising:
combining a first material in a frozen state with a portion of a freeze point suppressant; and
utilizing the combined first material with the portion of the freeze point suppressant to freeze a second material.

2. The method of claim 1, further comprising combining the second material in the frozen state with another portion of the freeze point suppressant.

3. The method of claim 1, wherein combining the first material in the frozen state with the portion of the freeze point suppressant melts the first material in the frozen state and forms the first material in a liquid state combined with the portion of the freeze point suppressant such that the combined first material in the liquid state with the freeze point suppressant has a temperature lower than a temperature of the first material in the frozen state.

4. The method of claim 1, wherein the first material and the second material are a same type of material.

5. The method of claim 4, wherein the same type of material includes at least water, an organic material, an ionic liquid, an inorganic material, or DMSO.

6. The method of claim 1, wherein the freeze point suppressant includes at least water, alcohol, ionic liquids, amines, ammonia, salt, non-salt soluble solids, organic liquid, inorganic liquid, mixtures of miscible materials, or a surfactant-stabilized mixtures of immiscible materials.

7. The method of claim 1, wherein utilizing the combined first material with the freeze point suppressant to freeze the second material includes utilizing an indirect heat exchanger thermally coupled with the combined first material with the freeze point suppressant to freeze the second material.

8. The method of claim 7, wherein utilizing the indirect heat exchanger includes:
exchanging heat between the combined first material and the freeze point suppressant with a first portion of a coolant passing through the indirect heat exchanger; and
exchanging heat between the cooled first portion of the coolant with an ice maker configured to freeze the second material.

9. The method of claim 8, further comprising:
passing a second portion of the coolant through a vapor compression cooled heat exchanger;
combining the cooled second portion of the coolant with the cooled first portion of the coolant; and
exchanging heat between the combined cooled first portion and cooled second portion of the coolant with the ice maker configured to freeze the second material.

10. The method of claim 1, wherein utilizing the combined first material with the freeze point suppressant to freeze the second material includes utilizing a first direct heat exchanger thermally coupled with the combined first material with the freeze point suppressant to freeze the second material.

11. The method of claim 10, further comprising:
exchanging heat between a coolant and a second direct heat exchanger to freeze the second material;
combining the coolant with the combined first material with the freeze point suppressant; and
bleeding off a portion of the coolant with the combined first material with the freeze point suppressant.

12. The method of claim 7, wherein utilizing the indirect heat exchanger includes:
passing a refrigerant through a condenser;
exchanging heat between the combined first material and freeze point suppressant with the refrigerant utilizing the indirect heat exchanger after the refrigerant passes through the condenser; and
passing the refrigerant through an expander before the refrigerant is utilized to facilitate freezing the second material.

13. The method of claim 12, wherein the refrigerant is utilized to facilitate freezing the second material through exchanging heat between the refrigerant and a coolant coupled with an ice maker configured to freeze the second material.

14. The method of claim 12, wherein the refrigerant is utilized to facilitate freezing the second material through exchanging heat between the refrigerant and a heat exchanger of an ice maker configured to freeze the second material.

15. The method of claim 1, wherein combining the first material in the frozen state with the portion of the freeze point suppressant includes mixing the first material in the frozen state with the portion of the freeze point suppressant through a hydraulic flow of the portion of the freeze point suppressant through the first material in the frozen state.

16. A system comprising:
a tank configured to combine a first material in a frozen state with a freeze point suppressant; and
one or more heat exchangers thermally coupled with the combined first material and the freeze point suppressant, wherein at least one of the one or more heat exchangers is configured to freeze a second material.

17. The system of claim 16, wherein:
at least one of the one or more heat exchangers is configured to thermally couple a coolant with the combined first material and freeze point suppressant; and
the coolant is thermally coupled with the heat exchanger configured to freeze the second material.

18. The system of claim 16, wherein at least one of the one or more heat exchangers is configured to thermally couple a refrigerant with the combined first material and freeze point suppressant and at least one of the one or more heat exchangers is configured to thermally couple the refrigerant with the coolant.

19. The system of claim 16, wherein the tank is configured to receive the frozen second material.

20. The system comprising:
a means for solidifying a first material;
a means for combining the first material in the solidified state with a freeze point suppressant; and
a means for thermally coupling the combined first material and the freeze point suppressant with the means for solidifying the first material.
